(19) United States
(12) Patent Application Publication
(10) Pub. No.: US 2024/0322577 A1
(43) Pub. Date: Sep. 26, 2024

(54) Mount for a Charging Station

(71) Applicant: Pre-Con Products, Simi Valley, CA (US)

(72) Inventor: David Zarraonandia, Thousand Oaks, CA (US)

(21) Appl. No.: 18/123,562

(22) Filed: Mar. 20, 2023

(51) Int. Cl. H02J 7/00; B60L 53/30

(52) U.S. Cl. CPC H02J 7/0042; B60L 53/30

(57) ABSTRACT

A mount for a charging station comprising a precast concrete base. The precast concrete base has a bottom surface, a top surface, a front surface, a rear surface, a first side surface, a second side surface, and a base height. The mount further comprises a through hole extending from the bottom surface to the top surface that is centrally located on the precast concrete base. The mount further comprises a plurality of non-through holes extending upward from the bottom surface toward the top surface that are adapted and configured to enable a user to increase the depth of each of the non-through holes to convert the plurality of non-through holes to a plurality of bollard mounting holes. The front surface, the rear surface, and the first and second side surfaces each comprise a thin-walled knockout portion adapted to be removed to create a cable passageway in the respective surface.

### CROSS-REFERENCE TO RELATED APPLICATIONS

Not Applicable.

### STATEMENT REGARDING FEDERALLY SPONSORED RESEARCH OR DEVELOPMENT

### Not Applicable.

### APPENDIX

Not Applicable.

### BACKGROUND OF THE INVENTION

### Field of the Invention

This invention pertains to a mount for a charging station.

### SUMMARY

One aspect of the disclosure is a mount for a charging station. The mount comprises a precast concrete base. The precast concrete base has a bottom surface, a top surface, a front surface, a rear surface, a first side surface, a second side surface, and a base height. The base height is the distance from the bottom surface to the top surface. The mount further comprises a through hole extending from the bottom surface to the top surface. The through hole is centrally located on the precast concrete base. The mount further comprises a plurality of non-through holes extending upward from the bottom surface toward the top surface. Each of the plurality of non-through holes has a depth that is less than the base height. Each of the plurality of non-through holes is adapted and configured to enable a user to increase the depth of said each of the plurality of non-through holes to convert the plurality of non-through holes to a plurality of bollard mounting holes. The non-through holes are sized for receiving bollards. The front surface, the rear surface, and the first and second side surfaces each comprise a thin-walled knockout portion adapted to be removed to create a cable passageway in the respective surface.

Another aspect of the disclosure is a mount for a charging station. The mount comprises a precast concrete base. The precast concrete base has a bottom surface, a top surface, a front surface, a rear surface, a first side surface, a second side surface, and a base height. The base height is the distance from the bottom surface to the top surface. The mount further comprises a through hole extending from the bottom surface to the top surface. The through hole is centrally located on the precast concrete base. The mount further comprises a plurality of bollard mounting holes extending upward from the bottom surface to the top surface. The mount further comprises a plurality of bollards. Each of the plurality of bollards extends through a corresponding one of the plurality of bollard mounting holes and projects above the top surface. The front surface, the rear surface, and the first and second side surfaces each comprise a thin-walled knockout portion adapted to be removed to create a cable passageway in the respective surface.

Yet another aspect of the disclosure is a mount for a charging station comprising a first mount portion and a second mount portion. Each of the first and second mount portions comprise a precast concrete base having a bottom surface, a top surface, a front surface, a rear surface, a first side surface, a second side surface, and a base height. The base height is the distance from the bottom surface to the top surface. Each of the first and second mount portions also comprise a through hole extending from the bottom surface to the top surface. The through hole is centrally located on the precast concrete base. Each of the first and second mount portions also comprise a plurality of non-through holes extending upward from the bottom surface toward the top surface. Each of the plurality of non-through holes have a depth that is less than the base height. Each of the plurality of non-through holes are adapted and configured to enable a user to increase the depth of said each of the plurality of non-through holes to convert the plurality of non-through holes to a plurality of bollard mounting holes. The non-through holes are sized for receiving bollards. For each of the first and second mount portions, the front surface, the rear surface, and the first and second side surfaces of the first and second mount portions each comprise a thin-walled knockout portion adapted to be removed to create a cable passageway in the respective surface. The first and second mount portions are operatively connected to form the mount.

Further features and advantages, as well as the operation, are described in detail below with reference to the accompanying drawings.

### BRIEF DESCRIPTION OF THE DRAWINGS

FIG. 1 is an isometric view of a mount for a charging station.

FIG. 2 is a bottom view of the mount for a charging station of FIG. 1.

FIG. 3. Is a top view of the mount for a charging station of FIG. 2.

FIG. 4 is a section view of the mount for a charging station, taken along the line 4-4 shown in FIG. 2.

FIG. 5 is an isometric view of the mount of FIGS. 1-4, but with knockout portions removed to form bollard mounting holes, and with bollard extending from the bollard mounting holes.

FIG. 6 is a section view of the mount for a charging station, taken along the line 6-6 shown in FIG. 5.

FIG. 7 is an isometric view of the mount for a charging station of FIG. 1 before the think-walled knockout portions are removed.

FIG. 8 is a section view of the mount for a charging station, taken along the line 8-8 shown in FIG. 7.

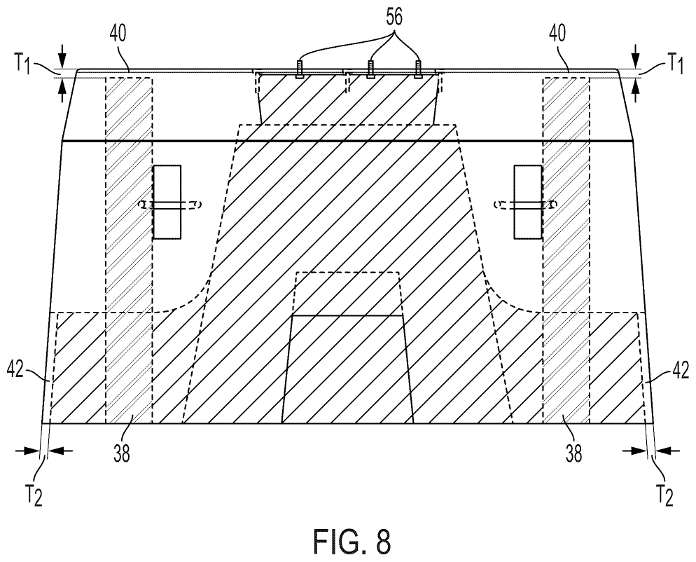

FIG. 9 is an isometric view of another embodiment of a mount for a charging station.

Reference numerals in the written specification and in the figure indicate corresponding items.

### DETAILED DESCRIPTION

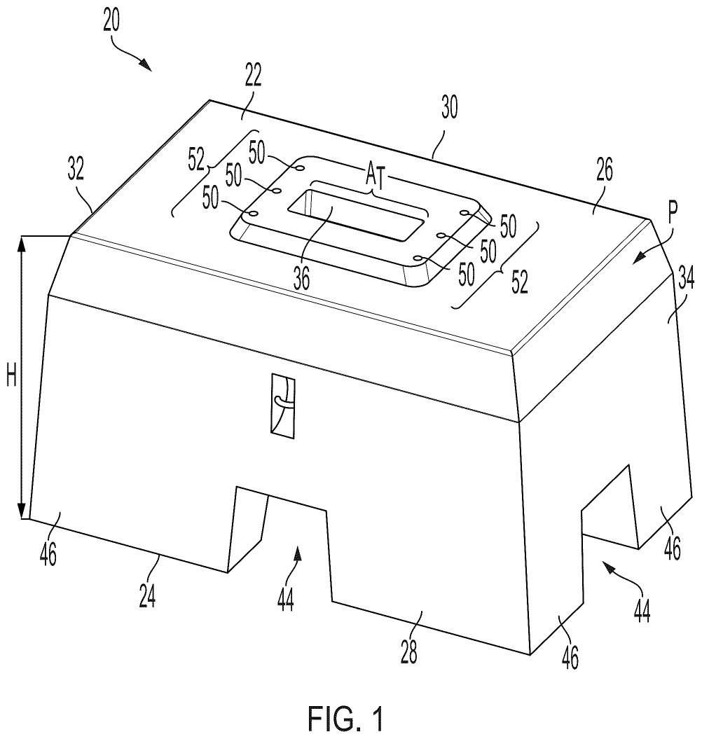

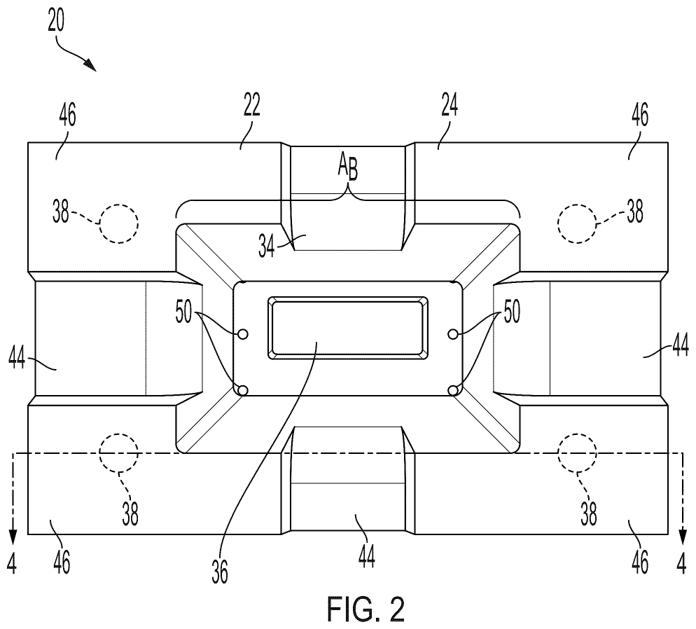

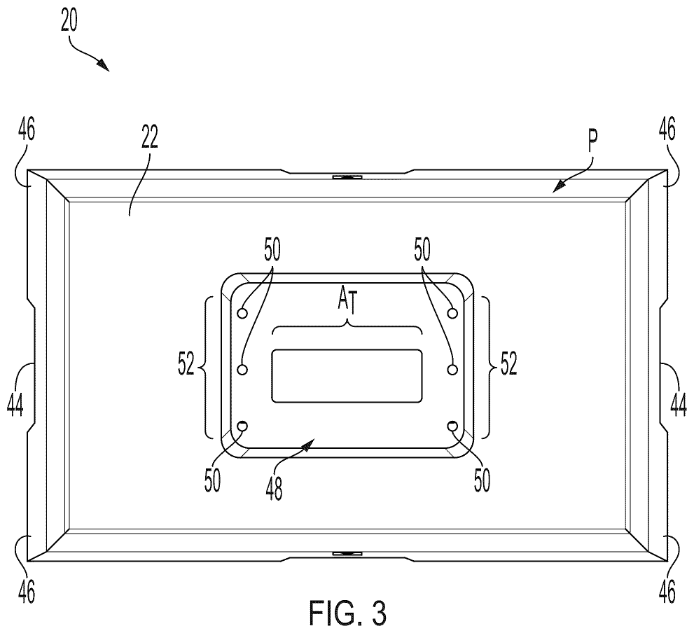

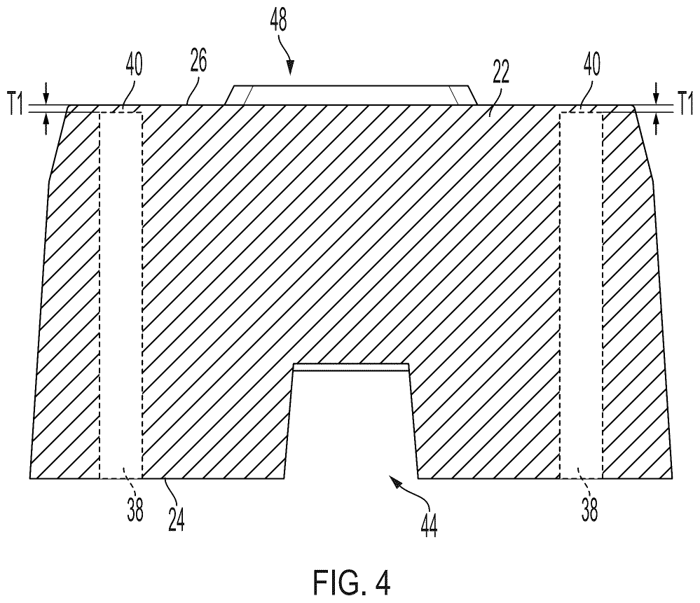

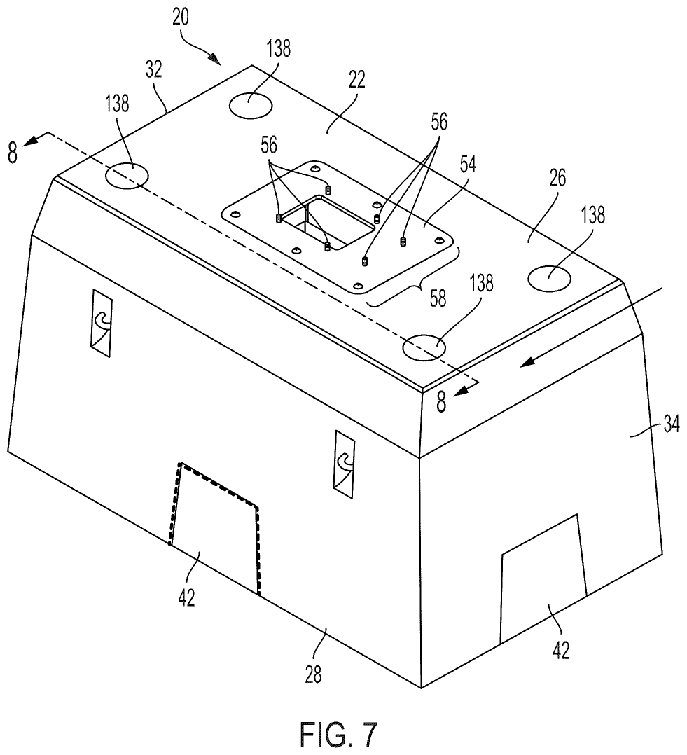

An embodiment of a mount for a charging station in accordance with the present disclosure is indicated generally by reference number 20 (FIGS. 1-4, 7). The mount 20 comprises a precast concrete base 22. The precast concrete base 22 has a bottom surface 24, a top surface 26, a front surface 28, a rear surface 30, a first side surface 32, a second side surface 34, and a base height H. The base height H is the distance from the bottom surface 24 to the top surface 26.

The mount 20 further comprises a through hole 36 extending from the bottom surface 24 to the top surface 26. The through hole 36 may be centrally located on the precast concrete base 22, or may be offset depending on the charging station used with the mount 20. The through hole 36 may be rectangular in a cross section taken in a plane parallel to the top surface 26. The through hole 36 may have a through hole top area AT and a through hole bottom area AB. The through hole 36 may taper outwardly from the top surface 26 to the bottom surface 24 such that the through hole top area AT is smaller than the through hole bottom area AB. This structure assists in the connection of electrical conduits to a charging station by providing a wide area in which to insert the cables, with a taper which allows the cables to slowly curve from the horizontal in-ground position to the generally upright position needed to connection the cables to the charging station.

The mount 20 further comprises a plurality of non-through holes 38 extending upward from the bottom surface 24 towards the top surface 26. Each of the plurality of non-through holes 38 has a depth that is less than the base height H. Each of the plurality of non-through holes 38 is adapted and configured to enable a user to increase the depth of said each of the plurality of non-through holes 38 to convert the plurality of non-through holes 38 to a plurality of bollard mounting holes. For example, the mount 20 may comprise a plurality of knockout portions 40. Each knockout portion 40 is adjacent a corresponding one of the plurality of non-through holes 38. Each knockout portion 40 has a thickness T1 of 0.5 to 1.5 inches. For example, each knockout portion 40 may have a thickness T1 of 0.75 inches±0.125 inches. Each knockout portion 40 is adapted to be removed to enable conversion of the non-through holes into bollard mounting holes.

The front surface 28, a rear surface 30, a first side surface 32, a second side surface 34 may each comprise a thin-walled knockout portion 42 adapted to be removed to create a cable passageway 44 in the respective surface. Each thin-walled knockout portion may have a thickness T2 of 1″ to 1.75″.

The bottom surface 24 of the mount 20 may comprise a plurality of feet 46. Each of the plurality of feet 46 may include a corresponding one of the plurality of non-through holes 38. When the thin-walled knockout portions 42 are removed from the precast concrete base 22, the cable passageways 44 are between adjacent feet of the plurality of feet 46. The cable passageways 44 are sized and positioned to enable an electric cable to extend through the through hole 36 and one of the plurality of cable passageways 44. For example, the through hole 36 and the plurality of cable passageways 44 may be adapted and configured to facilitate an electrical connection between a plurality of electrical conduits and a charging station.

The top surface 26 may comprise a raised area 48 adjacent the through hole 36 and corresponding to the shape of the through hole 36. The raised area 48 may be adapted and configured to prevent water from flowing into the through hole 36 when a charging station is connected to the mount 20. The raised area 48 may comprise a plurality of bolt holes 50 arranged in a first bolt pattern 52. The first bolt pattern 52 may correspond to the mounting holes of a charging station.

The mount 20 may further comprise an adapter plate 54. The adapter plate 54 is adapted and configured to be connected to the mount 20 via the plurality of bolt holes 50 of the raised area 48 of the mount 20. The adapter plate may further comprise a plurality of threated bolt holes 56 arranged in a second bolt pattern 58. The second bolt pattern 58 may correspond to the mounting holes of a second charging station. The first bolt pattern 52 of the first charging station may be different from the second bolt pattern 58 of the second charging station.

The top surface 26 may have a perimeter P, which is sloped to match a typical curb profile.

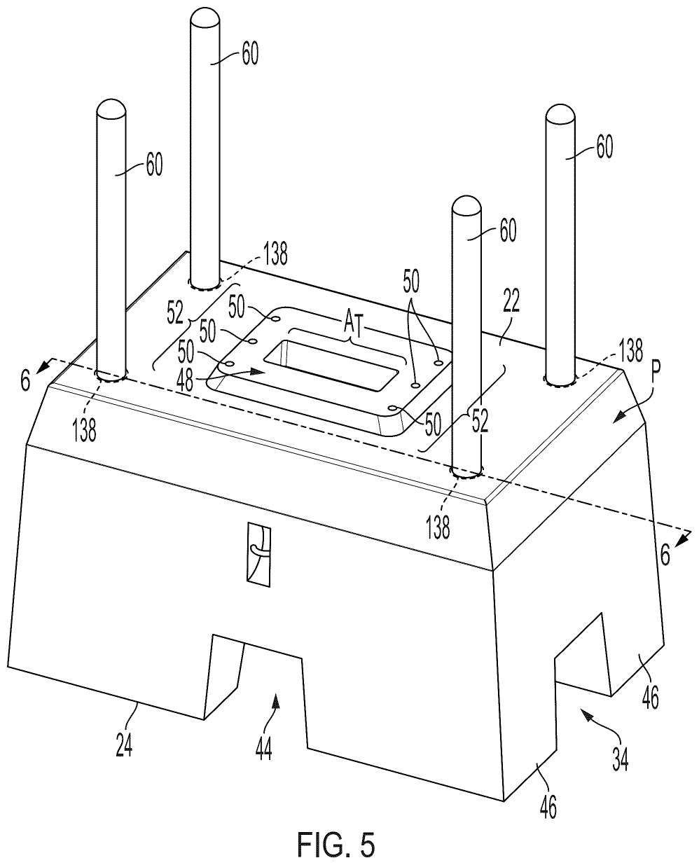

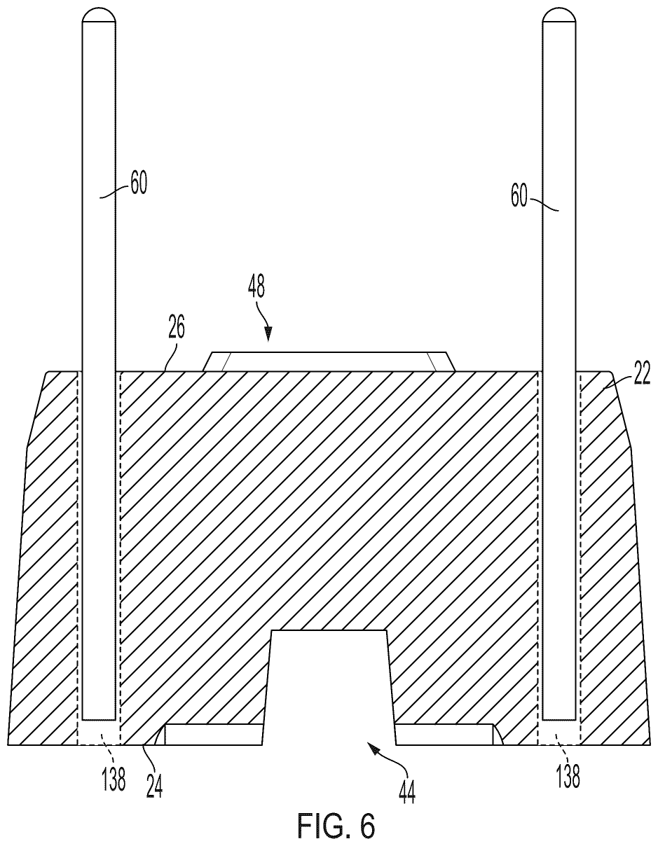

FIGS. 5-6 show the mount 20 with the knockout portions 40 removed to convert the non-through holes 38 into bollard mounting holes 138. As shown in FIGS. 5-6, a plurality of bollards 60 project upward from the bollard mounting holes 138. Lower portions of the bollards 60 may extend entirely through the bollard mounting holes 138, with upper portions of the bollards projecting upward from the top surface 26. Although FIGS. 5-6 show four bollards, it is to be understood that a user could choose to convert fewer of the non-through holes 38 into bollard mounting holes 138, if only one, two, or three bollards was desired for a particular installation. It is also to be understood that although the mount 20 is shown and described as being precast with four knockout portions 40, the mount could alternatively be pre-cast with one, two, three, or four bollard mounting holes.

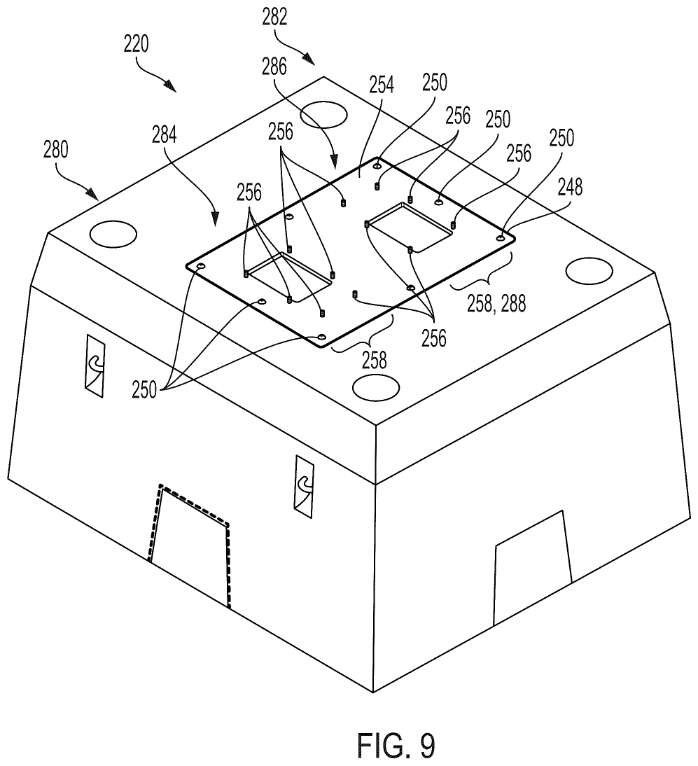

FIG. 9 shows an alternative embodiment of a mount for a charging station 220. The mount 220 comprises a first mount portion 280 and a second mount portion 282. Each mount portion may comprise all of the elements of the mount 20 as discussed above. Thus, the discussion of the mount 20 applies equally to each of the first and second mount portions 280, 282. The first and second mount portions are operatively connected to form the mount 220. The adapter plate 254 may comprise a first adapter portion 284 and a second adapter portion 286. The first adapter portion 284 may be operatively connected to the first mount portion 280 and the second adapter portion 286 may be operatively connected to the second mount portion 282. Each of the first and second adapter portions 284, 286 may be adapted and configured to be connected to the respective mount portion 280, 282 via the plurality of bolt holes 250 of the raised area 248 of the respective mount portion 280, 282. Each of the first and second portions 280, 282 of the adapter plate 254 may comprise a plurality of threaded bolt holes 256 arranged in a second bolt pattern 258. The second bolt pattern 258 may correspond to the mounting holes of a second charging station. The first bolt pattern 252 of the first charging station may be different from the second bolt pattern 258 of the second charging station.

Alternatively, the second adapter portion 286 of the of the adapter plate 254 may comprise a plurality of threaded bolt holes 256 arranged in a third bolt pattern 288. The third bolt pattern 288 may be different from the first and second bolt patterns 252, 258 and may correspond to the mounting holes of a third charging station. In this manner, the adapter plate 254 may allow the mount 220 to connect to two different types of charging stations simultaneously.

In view of the foregoing, it should be appreciated that the invention has several advantages over the prior art.

It should also be understood that when introducing elements of the present invention in the claims or in the above description of exemplary embodiments of the invention, the terms “comprising,” “including,” and “having” are intended to be open-ended and mean that there may be additional elements other than the listed elements. Additionally, the term “portion” should be construed as meaning some or all of the item or element that it qualifies. Moreover, use of identifiers such as first, second, and third should not be construed in a manner imposing any relative position or time sequence between limitations.

As various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A mount for a charging station, the mount comprising:
a precast concrete base having a bottom surface, a top surface, a front surface, a rear surface, a first side surface, a second side surface, and a base height, the base height being the distance from the bottom surface to the top surface;
a through hole extending from the bottom surface to the top surface, the through hole being centrally located on the precast concrete base;
a plurality of non-through holes extending upward from the bottom surface toward the top surface, each of the plurality of non-through holes having a depth that is less than the base height, each of the plurality of non-through holes being adapted and configured to enable a user to increase the depth of said each of the plurality of non-through holes to convert the plurality of non-through holes to a plurality of bollard mounting holes, the non-through holes being sized for receiving bollards; and
wherein the front surface, the rear surface, and the first and second side surfaces each comprise a thin-walled knockout portion adapted to be removed to create a cable passageway in the respective surface.

2. The mount of claim 1, wherein the bottom surface comprises a plurality of feet and, when the thin-walled knockout portions are removed from the precast concrete base, the cable passageways are between adjacent feet of the plurality of feet, and wherein the cable passageways and the through hole are sized and positioned to enable an electric cable to extend through the through hole and one of the plurality of cable passageways.

3. The mount of claim 2 wherein each thin-walled knockout portion has a thickness of 1″ to 1.75″.

4. The mount of claim 2 wherein each of the plurality of feet includes a corresponding one of the plurality of bollard mounting holes.

5. The mount of claim 4 further comprising a plurality of knockout portions, each knockout portion being adjacent a corresponding one of the plurality of non-through holes, each knockout portion having a thickness of 0.5 to 1.5 inches, each knockout portion being adapted to be removed to enable conversion of the non-through holes into the plurality of bollard mounting holes.

6. The mount of claim 2, wherein the through hole has a through hole top area and a through hole bottom area, and the through hole tapers outwardly from the top surface to the bottom surface such that the through hole top area is smaller than the through hole bottom area.

7. The mount of claim 6, wherein the through hole is rectangular in a cross section taken in a plane parallel to the top surface.

8. The mount of claim 6 wherein the through hole and the plurality of cable passageways are adapted and configured to facilitate an electrical connection between a plurality of electrical conduits and a charging station.

9. The mount of claim 7 wherein the top surface comprises a raised area adjacent the through hole and corresponding to the shape of the through hole, the raised area being adapted and configured to prevent water from flowing into the through hole when a charging station is connected to the mount.

10. The mount of claim 9 wherein the raised area comprises a plurality of bolt holes arranged in a first bolt pattern, the first bolt pattern corresponding to the mounting holes of a first charging station.

11. The mount of claim 10 wherein the mount further comprises an adapter plate, the adapter plate being adapted and configured to be connected to the mount via the plurality of bolt holes of the raised area of the mount, the adapter plate comprising a plurality of threaded bolt holes arranged in a second bolt pattern, the second bolt pattern corresponding to the mounting holes of a second charging station, the first bolt pattern of the first charging station being different from the second bolt pattern of the second charging station.

12. The mount of claim 11 wherein the top surface has a perimeter, the perimeter being sloped to match a typical curb profile.

13. A mount for a charging station, the mount comprising
a precast concrete base having a bottom surface, a top surface, a front surface, a rear surface, a first side surface, a second side surface, and a base height, the base height being the distance from the bottom surface to the top surface;
a through hole extending from the bottom surface to the top surface, the through hole being centrally located on the precast concrete base;
a plurality of bollard mounting holes extending upward from the bottom surface to the top surface;
a plurality of bollards, each of the plurality of bollards extending through a corresponding one of the plurality of bollard mounting holes and projecting above the top surface; and
wherein the front surface, the rear surface, and the first and second side surfaces each comprise a thin-walled knockout portion adapted to be removed to create a cable passageway in the respective surface.

14. The mount of claim 13, wherein the bottom surface comprises a plurality of feet and, when the thin-walled knockout portions are removed from the precast concrete base, the cable passageways are between adjacent feet of the plurality of feet, and wherein the cable passageways and the through hole are sized and positioned to enable an electric cable to extend through the through hole and one of the plurality of cable passageways, each of the cable passageways having a depth not greater than 50% of the base height.

15. The mount of claim 14, wherein the through hole has a through hole top area and a through hole bottom area, and the through hole tapers outwardly from the top surface to the bottom surface such that the through hole top area is smaller than the through hole bottom area.

16. The mount of claim 15, wherein the through hole is rectangular in a cross section taken in a plane parallel to the top surface.

17. The mount of claim 15 wherein the through hole and the plurality of cable passageways are adapted and configured to facilitate an electrical connection between a plurality of electrical conduits and a charging station.

18. The mount of claim 17 wherein the top surface comprises a raised area adjacent the through hole and corresponding to the shape of the through hole, the raised area being adapted and configured to prevent water from flowing into the through hole when a charging station is connected to the mount.

19. The mount of claim 18 wherein the raised area comprises a plurality of bolt holes arranged in a first bolt pattern, the first bolt pattern corresponding to the mounting holes of a charging station.

20. The mount of claim 19 wherein the mount further comprises an adapter plate, the adapter plate being adapted and configured to be connected to the mount via the plurality of bolt holes of the raised area of the mount, the adapter plate comprising a plurality of threaded bolt holes arranged in a second bolt pattern, the second bolt pattern corresponding to the mounting holes of a second charging station, the first bolt pattern of the first charging station being different from the second bolt pattern of the second charging station.

21. A mount for a charging station comprising:
a first mount portion and a second mount portion, each of the first and second mount portions comprising:
a precast concrete base having a bottom surface, a top surface, a front surface, a rear surface, a first side surface, a second side surface, and a base height, the base height being the distance from the bottom surface to the top surface;
a through hole extending from the bottom surface to the top surface, the through hole being centrally located on the precast concrete base;
a plurality of non-through holes extending upward from the bottom surface toward the top surface, each of the plurality of non-through holes having a depth that is less than the base height, each of the plurality of non-through holes being adapted and configured to enable a user to increase the depth of said each of the plurality of non-through holes to convert the plurality of non-through holes to a plurality of bollard mounting holes, the non-through holes being sized for receiving bollards;
wherein the front surface, the rear surface, and the first and second side surfaces of the first and second mount portions each comprise a thin-walled knockout portion adapted to be removed to create a cable passageway in the respective surface; and
wherein the first and second mount portions are operatively connected to form the mount.

22. The mount of claim 21 wherein the top surfaces of both of the first and second mount portions comprise a raised area adjacent the through hole and corresponding to the shape of the through hole, the raised area being adapted and configured to prevent water from flowing into the through hole when a charging station is connected to the mount.

23. The mount of claim 22 wherein the raised area of both of the first and second mount portions comprise a plurality of bolt holes arranged in a first bolt pattern, the first bolt pattern corresponding to the mounting holes of a charging station.

24. The mount of claim 23 wherein the mount further comprises an adapter plate, the adapter plate comprising a first adapter portion and a second adapter portion, the first adapter portion being operatively connected to the first mount portion and the second adapter portion being operatively connected to the second mount portion, each of the first and second adapter portions being adapted and configured to be connected to the respective mount portion via the plurality of bolt holes of the raised area of the respective mount portion, each of the first and second portions of the adapter plate comprising a plurality of threaded bolt holes arranged in a second bolt pattern, the second bolt pattern corresponding to the mounting holes of a second charging station, the first bolt pattern of the first charging station being different from the second bolt pattern of the second charging station.

25. The mount of claim 23 the mount further comprises an adapter plate, the adapter plate comprising a first adapter portion and a second adapter portion, the first adapter portion being operatively connected to the first mount portion and the second adapter portion being operatively connected to the second mount portion, each of the first and second adapter portions being adapted and configured to be connected to the respective mount portion via the plurality of bolt holes of the raised area of the respective mount portion, the first adapter portion of the adapter plate comprising a plurality of threaded bolt holes arranged in a second bolt pattern, the second bolt pattern corresponding to the mounting holes of a second charging station, the first bolt pattern of the first charging station being different from the second bolt pattern of the second charging station, the second adapter portion of the of the adapter plate comprising a plurality of threaded bolt holes arranged in a third bolt pattern, the third bolt pattern being different from the first and second bolt patterns and corresponding to the mounting holes of a third charging station.

26. A charging station assembly comprising the mount of claim 24, a first charging station, and a second charging station, the first charging station being connected to the first adapter portion and the second charging station being connected to the second adapter portion, the first and second charging stations being of the same type of charging station.

27. A charging station assembly comprising the mount of claim 25, a first charging station, and a second charging station, the first charging station being connected to the first adapter portion and the second charging station being connected to the second adapter portion, the first and second charging stations being of different types from one another.
